(19) United States
(12) Patent Application Publication
(10) Pub. No.: US 2025/0338822 A1
(43) Pub. Date: Nov. 6, 2025

(54) PET WATER DISPENSER

(71) Applicant: Shenzhen Beibanqiu Network Technology Co., Ltd., Shenzhen (CN)

(72) Inventor: Xiangli ZHANG, Shenzhen (CN)

(73) Assignee: Shenzhen Beibanqiu Network Technology Co., Ltd., Shenzhen (CN)

(21) Appl. No.: 19/270,415

(22) Filed: Jul. 15, 2025

(30) Foreign Application Priority Data
Jun. 18, 2025 (CN) 202521250093.3

(51) Int. Cl. A01K 7/02

(52) U.S. Cl. CPC A01K 7/025; A01K 7/022

(57) ABSTRACT

A pet water dispenser comprises an integrally formed housing, whose bottom is provided with a water inlet, and a water outlet is provided on a peripheral side of the housing. The housing is provided with a water pump module and a power supply module that are electrically connected to each other. The water pump module is configured to pump liquid from the water inlet to the water outlet. The water pump module and the power supply module are installed within the integrally formed housing. This configuration is convenient for users to clean the housing, saves splicing steps of the water pump module and the power supply module, eliminates connection structure between the two and reduces probability of water infiltration on the housing to improve waterproof performance of the pet water dispenser.

### RELATED APPLICATIONS

The present patent document claims the benefit of priority to patent Application No. 202521250093.3, filed Jun. 18, 2025, and entitled “PET WATER DISPENSER,” the entire contents of each of which are incorporated herein by reference.

### BACKGROUND

### 1. Technical Field

The present invention relates the technical field of pet supplies, and in particularly to a pet water dispenser.

### 2. Background Information

In modern life, people pay extreme attention to the health of their pets, and water intake is a critical factor affecting the health of the pets.

In the existing technology, a water pump module and a power supply module of a water dispenser are designed as separate units, the pump module must be placed in the water, and this configuration imposes specific waterproofing requirements on the water pump module. However, conventional water pump modules typically achieve waterproofing by glue sealing, which complicates the manufacturing process and leads to a certain defect rate.

### BRIEF SUMMARY

In order to overcome the shortcomings of the existing technology, the present invention provides a pet water dispenser with excellent waterproof performance.

The technical solution adopted by the present invention to solve its technical problems is as follows:

A pet water dispenser comprises an integrally formed housing, wherein a bottom of the housing is provided with a water inlet, and a water outlet is provided on a peripheral side of the housing; the housing is provided with a water pump module and a power supply module, the power supply module is electrically connected to the water pump module, and the water pump module is configured to pump liquid from the water inlet to the water outlet.

The pet water dispenser as described above, a filter element module is detachably connected to the water inlet, wherein the filter element module includes a filter element bracket detachably connected to the housing, and a filter element installed within the filter element bracket. The filter element bracket is provided with multiple water inlet holes, the filter element closely adjoins the water inlet, and the filter element is configured to filter to filter water entering the housing.

The pet water dispenser as described above, it further comprises a water storage container, and the housing is detachably connected to the water storage container. The bottom of the housing is connected with a water-level detector, which is configured to detect the water level in the water storage container.

The pet water dispenser as described above, the filter element bracket includes a first installation chamber and a second installation chamber, the filter element is installed in the first installation chamber, and the water-level detector extends into the second installation chamber.

The pet water dispenser as described above, the filter element has a larger volume than that of the first installation chamber.

The pet water dispenser as described above, an induction radar is fixed on the housing, and the induction radar is communicatively connected to the water pump module. The induction radar is configured to detect moving creatures within a range of 0.6-1.5 m, when the induction radar detects the moving creatures, it sends a working signal to the water pump module, and the water pump module activates to pump water.

The pet water dispenser as described above, an inner wall of the housing is provided with a water flow channel, one end of the water flow channel is connected to the water outlet and the other end is connected to the water pump module.

The pet water dispenser as described above, the power supply module is arranged adjacent to the water flow channel.

The pet water dispenser as described above, the water flow channel is integrally formed with the housing.

The pet water dispenser as described above, the water flow channel is arranged from top to bottom along the height direction of the housing.

The present invention has the following beneficial effects.

The water pump module and the power supply module are both installed within the integrally formed housing. This configuration is convenient for users to clean the housing, saves the splicing steps of the water pump module and the power supply module, eliminates the connection structure between the two and reduces the probability of water infiltration on the housing to improve the waterproof performance of the pet water dispenser. Additionally, this configuration further eliminates the hassle of disassembling or assembling the water pump module and the power module for users.

### BRIEF DESCRIPTION OF THE DRAWINGS

The present invention is further illustrated below in combination with the accompanying drawings and embodiments.

FIG. 1 is a perspective schematic view of a pet water dispenser.

FIG. 2 is a perspective schematic view of the pet water dispenser with a water storage container omitted.

FIG. 3 is a cross-sectional view of FIG. 2.

FIG. 4 is another cross-sectional view of FIG. 2.

FIG. 5 is a cross-sectional view of FIG. 3.

FIG. 6 is an exploded view of FIG. 2.

The reference numerals are as follows:
housing 1, water inlet 11, water outlet 12, water flow channel 13, water pump module 2, impeller 21, impeller driving part 22, filter element module 3, filter element bracket 31, filter element 32, water inlet hole 311, water storage container 4, water-level detector 41, first installation chamber 301, second installation chamber 302, induction radar 5, power supply module 6, battery bracket 61, battery 62.

### DETAILED DESCRIPTION OF THE DRAWINGS AND THE PRESENTLY PREFERRED EMBODIMENTS

The conception, specific structure, and technical effects of the present invention will be clearly and completely illustrated below in conjunction with embodiments and accompanying drawings, so as to fully understand the objectives, features, and advantages of the present invention. Apparently, the described embodiments are merely a part of the embodiments of the present invention, but not all of the embodiments. Based on the embodiments of the present invention, all other embodiments obtained by those of ordinary skill in the art without exerting creative efforts shall fall within the protection scope of the present invention. Additionally, all connection or coupling relationships involved in the patent do not mean that components are directly connected, but that a better connection structure can be formed by adding or reducing the connection accessories according to the specific embodiments. Each technical feature in the creation of the present invention can be combined interactively without conflicting with each other.

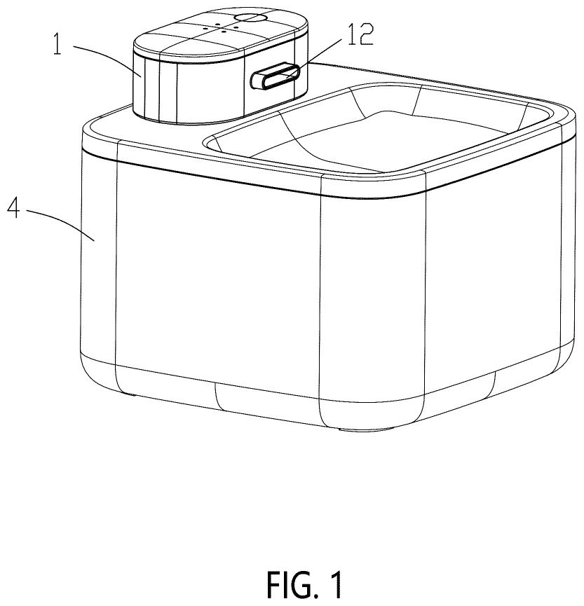

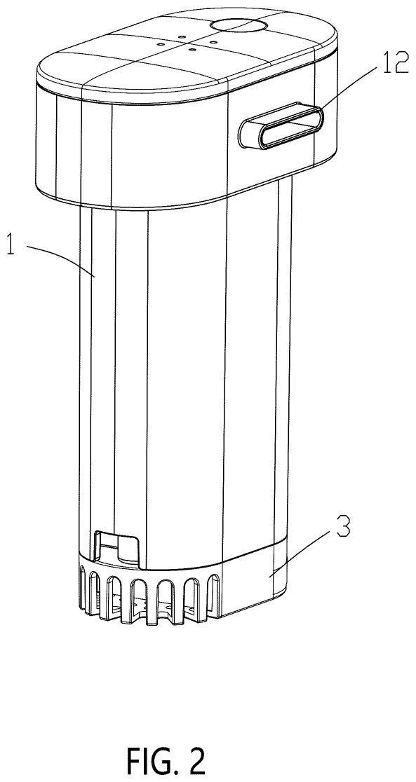

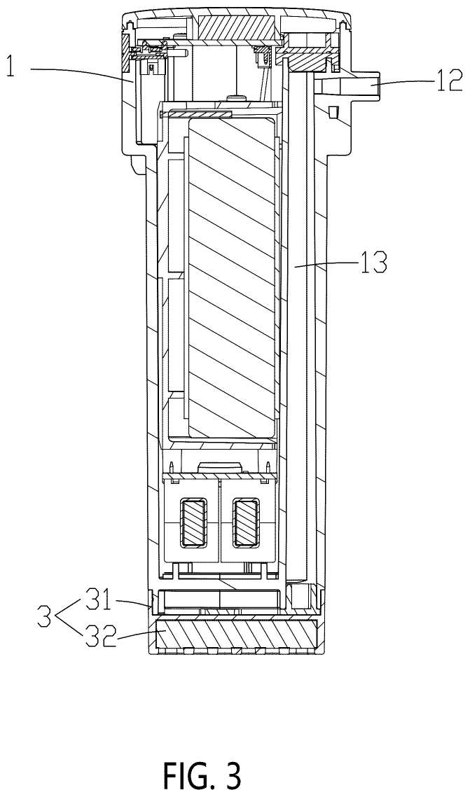

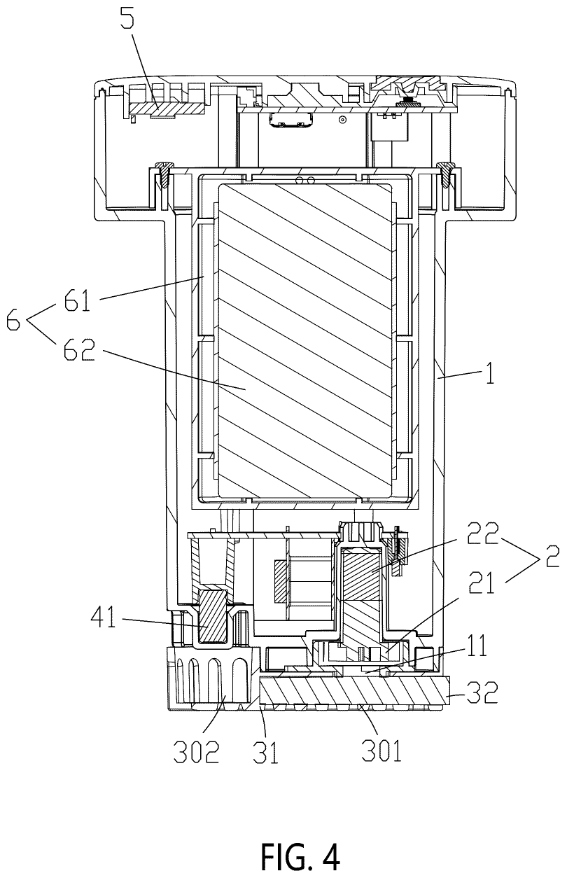

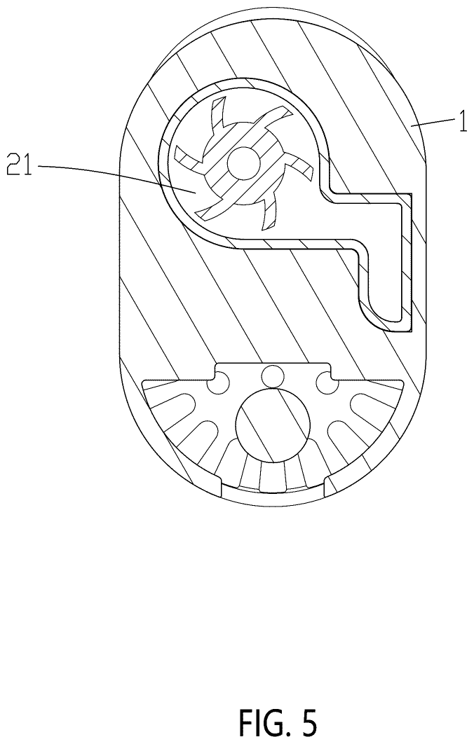

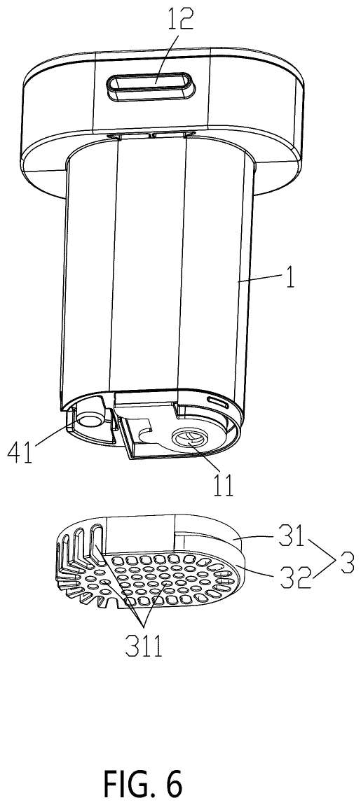

Referring to FIGS. 1 to 6, a pet water dispenser comprises an integrally formed housing 1, wherein a bottom of the housing 1 is provided with a water inlet 11, and a water outlet 12 is provided on a peripheral side of the housing 1. The housing 1 is provided with a water pump module 2 and a power supply module 6, the power supply module 6 is electrically connected to the water pump module 2, the power supply module 6 is configured to supply power to the water pump module 2, and the water pump module 2 is configured to pump liquid from the water inlet 11 to the water outlet 12.

When in use, the water dispenser can be inserted into a water bucket, the water pump module 2 operates to draw the water from the water bucket and discharge it through the water outlet 12.

The water pump module 2 and the power supply module 6 are both installed within the integrally formed housing 1. This configuration is convenient for users to clean the housing, saves the splicing steps of the water pump module 2 and the power supply module 6, eliminates the connection structure between the two and reduces the probability of water infiltration on the housing 1 to improve the waterproof performance of the pet water dispenser. Additionally, this configuration further eliminates the hassle of disassembling or assembling the water pump module 2 and the power module 6 for users.

The water inlet 11 is arranged at the bottom of the housing 1. Compared to being arranged on the peripheral side of the housing 1, the water inlet 11 at the bottom can draw water from the bottom of the water bucket, so as to reduce the water accumulated at the bottom of the water bucket and prevent bacterial growth, thereby protecting the health of pets.

Specifically, in this embodiment, the water pump module 2 includes an impeller 21 and an impeller driving part 22. A fixed end of the impeller driving part 22 is fixed inside the housing 1, and a rotational center of the impeller 21 is connected to an output end of the impeller driving part 22. The impeller driving part 22 outputs power to drive the impeller 21 to rotate, thereby pumping liquid from the water inlet 11 to the water outlet 12 to achieve the water extraction function.

Specifically, the power supply module 6 includes a battery bracket 61 installed within the housing 1 and a battery 62 fixedly arranged on the battery bracket 61.

More specifically, the battery 62 is a lithium battery.

In one embodiment, a filter element module 3 is detachably connected to the water inlet 11, wherein the filter element module 3 includes a filter element bracket 31 detachably connected to the housing 1, and a filter element 32 installed within the filter element bracket 31. The filter element bracket 31 is provided with multiple water inlet holes 311, the filter element 32 closely adjoins the water inlet 11, and the filter element 32 is configured to filter to filter water entering the housing 1.

When the water pump module 2 is activated, water enters the filter element 32 through the water inlet holes 311. The filter element 32 filters out impurities in the water, and the filtered water then flows into the housing 1 through the water inlet 11 and flows out from the water outlet 12.

The filter element 32 can effectively trap particulate impurities in the water and prevent these impurities from entering the water pump module 2, thereby prolonging the service life of the water pump. Besides, it can also avoid pets eating the impurities and protect their health.

Specifically, the filter element module 3 is engaged with the water inlet 11 through a snap-fit connection.

Specifically, the water inlet holes 311 are distributed on the bottom and peripheral sides of the filter element bracket 31. Water is drawn in from the peripheral sides and bottom of the filter element bracket 31, which has wide intake coverage and high filtration efficiency.

In one embodiment, the filter element bracket 31 includes a first installation chamber 301 and a second installation chamber 302, the filter element 32 is installed in the first installation chamber 301, and the water-level detector 41 extends into the second installation chamber 302.

In one embodiment, the filter element 32 has larger volume than that of the first installation chamber 301. The filter element 32 is large in volume, which has stronger ability to absorb and trap impurities. Before entering the water inlet 11, the water is filtered by the filter element 32, so that cleaner water is flowed out from the water outlet 12. Besides, the larger filter element 32 can accommodate more impurities and is not easy to be clogged. Additionally, the filter element 32 with larger volume ensures a tighter fit between the filter element 32 and the installation chamber, the stability is better after installation, thereby reducing sloshing or displacement during operation.

Specifically, the filter element 32 has elasticity and forms an interference fit with the filter element bracket 31, thereby fixing the filter element 32 on the filter element bracket 31.

In one embodiment, the pet water dispenser further comprises a water storage container 4. The housing 1 is detachably connected to the water storage container 4, and a water-level sensor 41 is provided on the bottom of the housing 1. The water-level sensor 41 is configured to detect the water level in the storage container 4, which can remind users to refill water in time and prevent dehydration for pets.

In one embodiment, an induction radar 5 is fixed on the housing 1, and the induction radar 5 is communicatively connected to the water pump module 2. The induction radar 5 is configured to detect moving creatures within a range of 0.6 to 1.5 meters, when the induction radar 5 detects the moving creatures, it sends a working signal to the water pump module 2, and the water pump module 2 activates to pump water.

The induction radar 5 improves the intelligence degree of the pet water dispenser. When a pet approaches within the range of 0.6-1.5 m, the water pump module 2 activates to pump water, ensuring that the pet can drink clean water at any time. This is especially ideal for busy owners, eliminating concerns about delayed hydration for their pets. Setting the induction range of 0.6-1.5 m can not only effectively detect the proximity of the pets, but also avoids false triggers caused by an overly large induction range, thereby improving the stability and reliability of the device.

In one embodiment, an inner wall of the housing 1 is provided with a water flow channel 13, one end of the water flow channel 13 is connected to the water outlet 12, and the other end is connected to the water pump module 2. The water flow channel 13 is configured to guide the flow direction of water and guide the flow path of water, thereby directing the water drawn from the water inlet 11 to the water outlet 12.

In one embodiment, the power supply module 6 is arranged adjacent to the water flow channel 13, so that the structure is compact, thus to reduce the volume of the pet water dispenser.

In one embodiment, the water flow channel 13 is integrally formed with the housing 1, and a position of the water flow channel 13 is fixed to prevent displacement from the water inlet 11 and the water outlet 12 due to the collision, which will affect normal use of the pet water dispenser.

In one embodiment, the water flow channel 13 is arranged from top to bottom along the height direction of the housing 1.

The above provides detailed descriptions of preferred embodiments of the present invention. However, the scope of the present invention is not limited to the described embodiments. Those skilled in the art can make various equivalent modifications or substitutions without departing from the spirits of the present invention, and all such equivalent modifications or substitutions shall fall within the scope defined by the claims of the present invention.

1. A pet water dispenser, comprising an integrally formed housing, wherein a bottom of the housing is provided with a water inlet, and a water outlet is provided on a peripheral side of the housing; a water pump module and a power supply module are arranged in the housing, the power supply module is electrically connected to the water pump module, and the water pump module is configured to pump liquid from the water inlet to the water outlet.

2. The pet water dispenser according to claim 1, wherein a filter element module is detachably connected to the water inlet; the filter element module includes a filter element bracket detachably connected to the housing, and a filter element installed within the filter element bracket; the filter element bracket is provided with a plurality of water inlet holes, the filter element closely adjoins the water inlet, and the filter element is configured to filter to filter water entering the housing.

3. The pet water dispenser according to claim 2, further comprising a water storage container, wherein the housing is detachably connected to the water storage container, the bottom of the housing is connected with a water-level detector, and the water-level detector is configured to detect a water level in the water storage container.

4. The pet water dispenser according to claim 2, wherein the filter element bracket includes a first installation chamber and a second installation chamber, the filter element is installed in the first installation chamber, and the water-level detector extends into the second installation chamber.

5. The pet water dispenser according to claim 4, wherein the filter element has a larger volume than that of the first installation chamber.

6. The pet water dispenser according to claim 5, wherein the filter element has elasticity and forms an interference fit with the filter element bracket, thereby fixing the filter element on the filter element bracket.

7. The pet water dispenser according to claim 2, wherein an induction radar is fixed on the housing, and the induction radar is communicatively connected to the water pump module; the induction radar is configured to detect moving animals with a distance range of 0.6-1.5 m, when a moving animal is detected, the induction radar sends a working signal to the water pump module, and the water pump module activates to pump water.

8. The pet water dispenser according to claim 2, wherein the filter element module is engaged with the water inlet through a snap-fit connection.

9. The pet water dispenser according to claim 8, wherein the water inlet holes are distributed on bottom and peripheral sides of the filter element bracket.

10. The pet water dispenser according to claim 1, wherein an inner wall of the housing is provided with a water flow channel; one end of the water flow channel is connected to the water outlet, and the other end is connected to the water pump module.

11. The pet water dispenser according to claim 10, wherein the power supply module is arranged adjacent to the water flow channel.

12. The pet water dispenser according to claim 11, wherein the water flow channel is integrally formed with the housing.

13. The pet water dispenser according to claim 12, wherein the water flow channel is arranged from top to bottom along a height direction of the housing.

14. The pet water dispenser according to claim 1, wherein the water pump module includes an impeller and an impeller driving part, a fixed end of the impeller driving part is fixed inside the housing, and a rotational center of the impeller is connected to an output end of the impeller driving part.

15. The pet water dispenser according to claim 1, wherein the power supply module includes a battery bracket installed within the housing and a battery fixedly arranged on the battery bracket.
